(19) United States
(12) Patent Application Publication
(10) Pub. No.: US 2008/0212898 A1
(43) Pub. Date: Sep. 4, 2008

(54) IMAGE FORMING APPARATUS

(75) Inventor: Masahiro Iwadate, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/925,647

(22) Filed: Oct. 26, 2007

(30) Foreign Application Priority Data
Nov. 29, 2006 (JP) 2006-322524

(51) Int. Cl. G06K 9/54

(52) U.S. Cl. 382/305

(57) ABSTRACT

An image file may be stored in an image forming apparatus in both a device-specific and a general-purpose format. To appropriately select whether to store an image file in either or both formats, according to the image file being stored, an image forming apparatus that is connected to an external device inputs the image data via an image input unit, and uses a specific image generating unit to generate a P-JPEG data, a device-specific format. A general image generating unit generates a PDF data, in accordance with the P-JPEG data, that can be interpreted by the external device as well as the image forming apparatus, and both the P-JPEG data and the PDF data are stored in a storage unit. A control unit controls generating the PDF data by the general image generating unit, according to the box attributes of the storage unit.

### BACKGROUND OF THE INVENTION

1. Field of the Invention

The present invention relates to an image forming apparatus, in particular, an image forming apparatus that facilitates storage of an image of a device-specific format and an image of a general-purpose format.

2. Description of the Related Art

Conventionally, there is known an image processing apparatus that employs a proprietary encoding scheme or the like on input image data to facilitate generating an image in the device-specific format. As such an image processing apparatus, Japanese Patent Laid-Open No. 2004-135242, for example, proposes an apparatus that facilitates generating an image from a format that may be easily used on an external device, etc., including a host computer, in addition to the device-specific format.

As another example, Japanese Patent Laid-Open No. 2004-102412 proposes an apparatus that stores input data that is input from an image input apparatus, such as a scanner, in a plurality of data formats.

“Image format” may be substituted for “data format” in the present circumstance. For example, known typical image formats include JPEG, Packet JPEG, PDF, and BMP.

It is conceivable that such a conventional image forming apparatus as the foregoing would store a target image data which supports both a device-specific image format and a general-purpose image format, a format that is not device-specific, and thus, can be used with an external device, etc. Storing such target image data (“the target image data”) in a plurality of formats, however, consumes a large amount of storage space on a hard drive or the like.

Hereinafter, “device-specific image format” will be referred to as “specific format.” A format such as Packet JPEG is an archetype thereof. In similar fashion, an image format that is not device-specific will be referred to as “general format.” A general format such as PDF or TIFF is an archetype thereof.

Consider an image forming apparatus that stores the target image data in only a specific format. When transmitting the target image data to another apparatus that does support the specific format, it is necessary to convert the target image data to a general format prior to the transmission. Accordingly, in such a circumstance, additional time is involved from the time a user gives a transmission instruction to the time the transmission is actually executed, for the conversion thereof.

An image forming apparatus that stores the target image data in only a general format, on the other hand, requires converting the target image data to a specific format when performing a print of the target image data. Accordingly, in such a circumstance, additional time is involved from the time the user gives a print instruction to the time the print is actually executed, for the conversion thereof.

As an image data that is stored within an image forming apparatus, storing only as a specific format, only as a general format, or in both a specific and a general format all have their respective advantages and disadvantages. Accordingly, it would be desirable to select appropriately as to which format to apply, or whether to use both formats, in response to the target image data that is stored.

### SUMMARY OF THE INVENTION

According to one aspect of the present invention, an image forming apparatus that is connected to an external device via a network, the apparatus comprises: an image generating unit adapted to generating, in accordance with a first image data in a first format that the image forming apparatus is capable of interpreting, a second image data in a second format that the external device is capable of interpreting; a storing unit adapted to storing the first image data and the generated second image data; and a control unit adapted to controlling the generation of the second image data by the image generating unit, according to an attribute of the storing unit; wherein the attribute of the storing unit includes an information that denotes whether or not a sharing exists between the storing unit and the external device that is connected thereto via the network.

According to another aspect of the present invention, an image forming apparatus that is connected to an external device via a network, the apparatus comprises: an image generating unit adapted to generating, in accordance with a first image data in a first format that the image forming apparatus is capable of interpreting, a second image data in a second format that the external device is capable of interpreting; a storing unit adapted to storing the first image data and the generated second image data; and a control unit adapted to controlling the generation of the second image data by the image generating unit, according to an attribute of the storing unit; wherein the attribute of the storing unit includes an information that denotes a usage objective of the storing unit.

According to still another aspect of the present invention, an image forming apparatus that is connected to an external device via a network, the apparatus comprises: an image generating unit adapted to generating, in accordance with a first image data in a first format that the image forming apparatus is capable of interpreting, a second image data in a second format that the external device is capable of interpreting; a storing unit adapted to storing the first image data and the generated second image data; and a control unit adapted to controlling the generation of the second image data by the image generating unit, according to an attribute of the storing unit; wherein the information that denotes the usage objective of the storing unit includes an information that denotes whether to place a priority on printing, or on a usage by the external device.

According to yet another aspect of the present invention, an image forming apparatus that is connected to an external device via a network, the apparatus comprises: a first image generating unit adapted to generating a first image data in a first format that the image forming apparatus is capable of interpreting, in accordance with input image data; a second image generating unit adapted to generating a second image data in a second format that the external device is capable of interpreting, in accordance with the first image data; a storing unit adapted to storing the generated first image data and the generated second image data; and a control unit adapted to controlling the generation of the second image data by the second image generating unit, according to an attribute of the input image data.

According to still yet another aspect of the present invention, an image forming apparatus that is capable of interpreting an image data in a first format and is connected to an external device via a network, the apparatus comprises: an image input unit adapted to inputting a second image data in a second image format that the external device is capable of interpreting; a first image generating unit adapted to generating the image data in the first format in accordance with the input second image data; a storing unit adapted to storing the generated first image data and the input second image data; and a control unit adapted to controlling the generation of the first image data by the first image generating unit, according to a setting information pertaining to the second image data.

According to the present invention, which is formed from the preceding configuration, it would be possible to perform storage of input image data in an optimal format.

It would thus be possible to generate and maintain either or both of a first and a second format image according to a usage objective, without requiring a complicated operation on the part of the user, thus allowing giving equal consideration to convenience for the user on the one hand, and device performance on the other.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram depicting a configuration of an image forming apparatus according to a first embodiment of the present invention.

FIG. 2 depicts an example of a logical region that is maintained for storage according to the first embodiment.

FIG. 3 depicts an example of a box registration screen according to the first embodiment.

FIG. 4 depicts an example of a printer driver setting screen according to the first embodiment.

FIGS. 5A-5C are conceptual diagrams depicting a flow of an image data according to the first embodiment.

FIG. 6 is a flowchart depicting a PDF generation control process according to the first embodiment.

FIG. 7 is a flowchart depicting a PDF generation determination process based on box information, according to the first embodiment.

FIG. 8 is a flowchart depicting a PDF generation determination process based on PDL data setting information, according to the first embodiment.

FIG. 9 is a block diagram depicting a configuration of an image forming apparatus according to a second embodiment.

FIG. 10 depicts an example of a console operation screen that is displayed for a source manuscript extraction direction, according to the second embodiment.

FIGS. 11A-11C are conceptual diagrams depicting a flow of an image data according to the second embodiment.

FIG. 12 is a flowchart depicting a PDF generation control process according to the second embodiment.

FIG. 13 is a flowchart depicting a PDF generation control process according to the second embodiment.

FIG. 14 is a block diagram depicting a configuration of an image forming apparatus according to a third embodiment.

FIG. 15A and FIG. 15B are conceptual diagrams depicting a flow of image data according to the third embodiment.

FIG. 16 is a flowchart depicting a PDF reception control process according to the third embodiment.

FIG. 17 is a flowchart depicting a P-JPEG generation control process according to the third embodiment.

FIG. 18 is a flowchart depicting a P-JPEG generation determination process according to the third embodiment.

### DESCRIPTION OF THE EMBODIMENTS

The following is a detailed description of exemplary embodiments of the present invention, with reference to the attached drawings. It is to be understood, however, that the configuration elements disclosed according to the embodiments are exemplary, and the scope of the present invention is not restricted thereto in any way.

### First Embodiment

### Image Forming Apparatus Overview

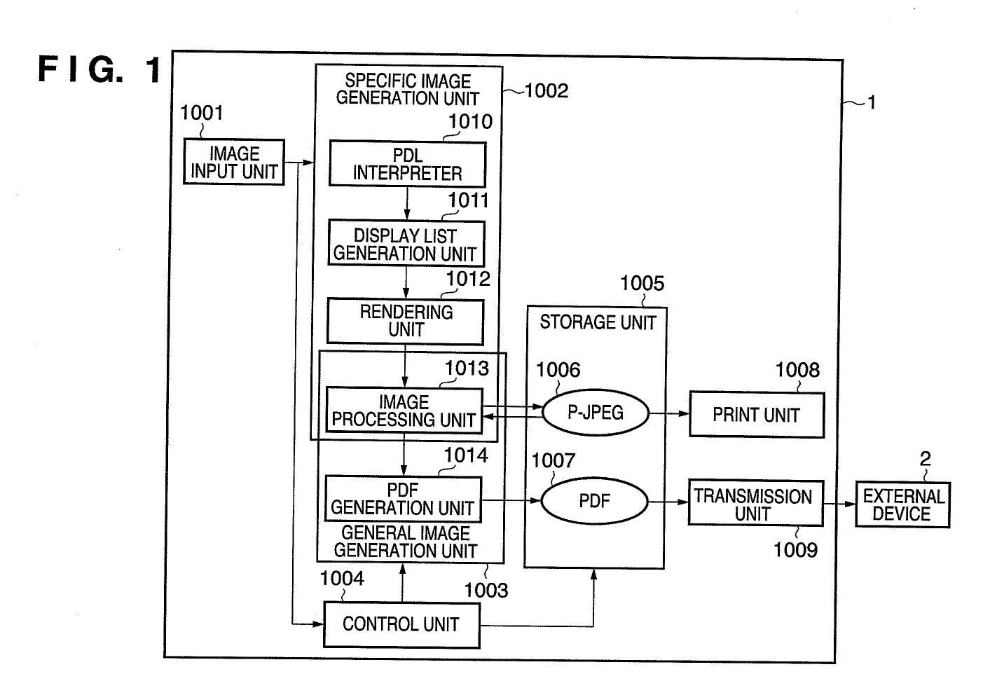

The following is a description of an overview of an image forming apparatus according to the embodiment. FIG. 1 is a block diagram depicting a configuration of an image forming apparatus according to the embodiment. An image forming apparatus 1 according to the embodiment is connected via a network (not shown), either wired or wireless, to an external device 2, such as a host computer.

For example, the image forming apparatus 1 receives PDL data from the external device 2, performs a required image process thereupon, and temporarily stores the processed PDL data on a storage unit 1005, such as a hard drive. Thereafter, the image forming apparatus 1 outputs the processed PDL data via a print unit 1008 or a transmission unit 1009. The storage on the storage unit 1005 is performed as either or both of P-JPEG data 1006, which is a Packet JPEG format that is a specific format of the image forming apparatus 1, and PDF data 1007, which is a general format that can even be used on the external device 2. The P-JPEG data 1006 is generated in a specific image generation unit 1002, and the PDF data 1007 is generated in a general image generation unit 1003. An image generation process of the specific image generation unit 1002 and the general image generation unit 1003, or a process of storing on the storage unit 1005, is controlled by a control unit 1004 that controls the image generation and the storage. A detailed description thereof will be provided hereinafter.

Logical Storage Region

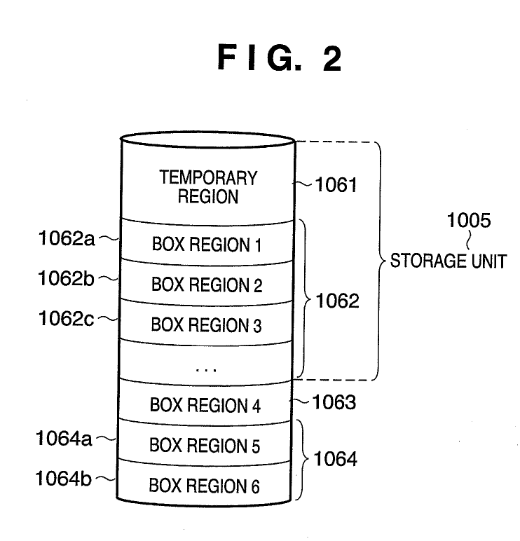

The following is a description pertaining to the storage unit 1005 of the image forming apparatus 1. FIG. 2 depicts an example of a logical region that is maintained for storage according to the embodiment. It would be possible, for example, to use a hard drive, a flash memory, or a hard drive on another apparatus, etc., as the storage unit 1005 of the image forming apparatus 1, according to the embodiment.

In FIG. 2, a temporary region 1061 and a box region 1062, which are logical regions, are maintained in the storage unit 1005 of the image forming apparatus 1. The temporary region 1061 logical region is erased by powering down the image forming apparatus 1, while the box region 1062 logical region is a back-up, which is not erased by powering down. The temporary region 1061 temporarily stores image data that is input from a device (not shown), etc., that is external to the image forming apparatus 1, or image data that is obtained by scanning the source manuscript. The box region 1062 stores the processed image data in order to facilitate the printing or transmission instruction by the user at a later time. The box region 1062 is partitioned into a plurality of small storage regions (box units) 1062a-1062c.

A logical region 1063 denotes a region that is maintained on a USB storage that is inserted into the image forming apparatus 1, and is capable of being used as a box region. The logical region 1063 denotes a logical region of a hard drive, etc., that is part of another image forming apparatus (not shown) other than the image forming apparatus 1. The logical region 1063 is capable of being used as a box region by the image forming apparatus 1.

It would be possible for the user to give a storage instruction of the image data via a console panel (not shown) on the image forming apparatus 1 to any of the box regions, as well as via a printer driver of the host computer that inputs the target image data.

Box Region Registration Process

The box region 1062 in the storage unit 1005 of the image forming apparatus 1 is configured of the plurality of unit box regions, each of which may be managed by a different user. Each respective user may thus direct which of the plurality of unit box regions is to be treated as the user's own unit box.

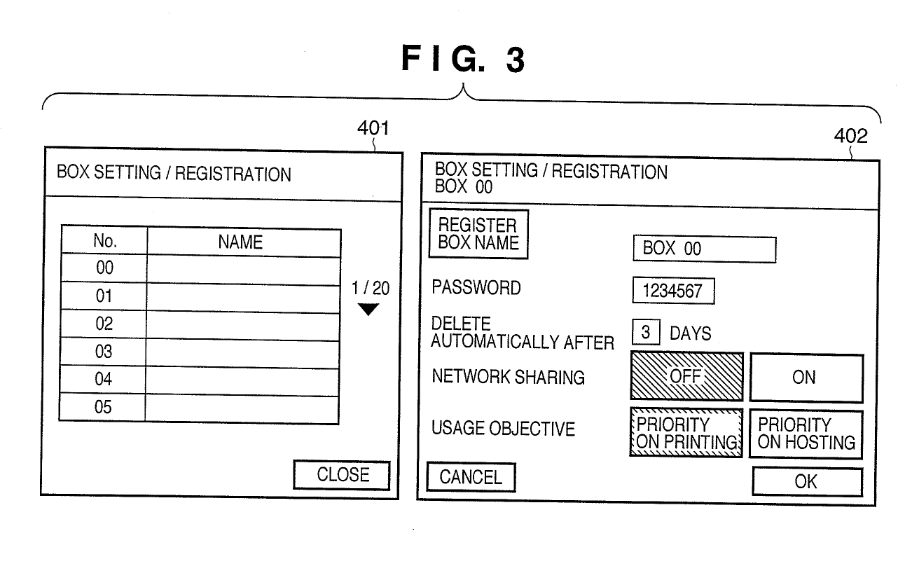

The following is a description of a transition of a screen that is displayed on a console panel (not shown) of the image forming apparatus 1, when the user directs an assignment of a personal box, with reference to FIG. 3.

In a screen 401, the user selects a box no. which the user wants to treat as the user's personal unit box, whereupon a screen 402 is displayed. The user is then able to input a content of a variety of setting items using the screen 402, such as a box name, a personal identity number, when to automatically erase the box, whether to enable a network sharing, or whether to prioritize a print or a host as an objective of using the unit box.

The following is a description of each respective setting item in the screen 402. A box name record is an input field wherein the user inputs a name that identifies each respective unit box. The password is an input field wherein the user inputs a password to prevent the user's unit box from being used by another person. An automatic erase is an input field wherein the user inputs an amount of time after an image data is stored in the unit box to maintain the data, whereafter the data is automatically erased. For example, if the user inputs “3” in the field, the data will be automatically erased three days after it is stored, whereas if the user inputs “0,” no automatic erasure will be performed on the image data.

A network share item is an input field wherein the user inputs whether or not to share the image data in the unit box over a network. If the user inputs “ON” in the field, it would be possible for the external device 2 to extract the image data in the unit box, and to view the image data on the external device 2. If, on the other hand, the user inputs “OFF” in the field, it would not be possible for the external device 2 to extract the image data in the unit box. Preventing the extraction of the image data in the unit box by the external device 2 improves security at the cost of reduced operability. Regardless of the setting of the field, the user will be able to transmit image data within the external device 2 to the user's own unit box within the image forming apparatus 1.

A usage objective field is an input field wherein the user inputs a primary objective of the unit box. A content of the setting, that is, a selectable usage objective, is a priority on printing, which makes printing a primary objective, and a priority on hosting, which makes using the unit box from the external device 2 a primary objective.

The user may register the user's own unit box on the image forming apparatus 1 by setting each respective described item, and selecting the OK button.

An Image Stored in the Box Region

Two types of image data are stored in the box region according to the embodiment: a specific format image data that is suited to being used within the image forming apparatus 1, and a general-purpose image format that is not specific, and can be easily used on the external device 2. The image forming apparatus 1 according to the embodiment is characterized by storing an image data in one or both of the formats, according to a prescribed condition.

The following is a description of respective advantages and disadvantages of the specific format and the general format.

An image data of the specific format receives an image format process that is optimized for a characteristic of, for example, a scanner or a printer, as well as receiving a proprietary encoding so as to allow rapid processing. Accordingly, printing is superior to the general format in terms of both printed image quality and performance. Using the image data of the specific format on the external device 2, however, requires a specialized application. It is not simple to use the image data of the specific format on the external device 2. Accordingly, transmitting the image data to the external device 2 typically involves converting the image data from the specific format to the general format prior to the transmission thereof.

An image data of the general format, on the other hand, is easily used on the external device 2, because no particular specialized application is required. Consequently, it is unnecessary to perform a format conversion when transmitting the image data to the external device 2. Printing the image data of the general format on the image forming apparatus 1, however, involves converting the image data of the general format to the specific format prior to executing the printing thereof. Even if it were possible to print the image data in the general format, that is, without performing the format conversion, an image process according to the characteristic of the device will not be applied to the image data, resulting in a decline in printout quality.

Thus, the image data of the specific format and the image data of the general format of the image forming apparatus 1 have respective advantages and disadvantages as per the foregoing. Accordingly, it is desirable to determine the format of the image data for the image forming apparatus 1 as circumstances dictate, with the advantages and disadvantages thereof taken into consideration.

Transmission of PDL Data to Image Forming Apparatus

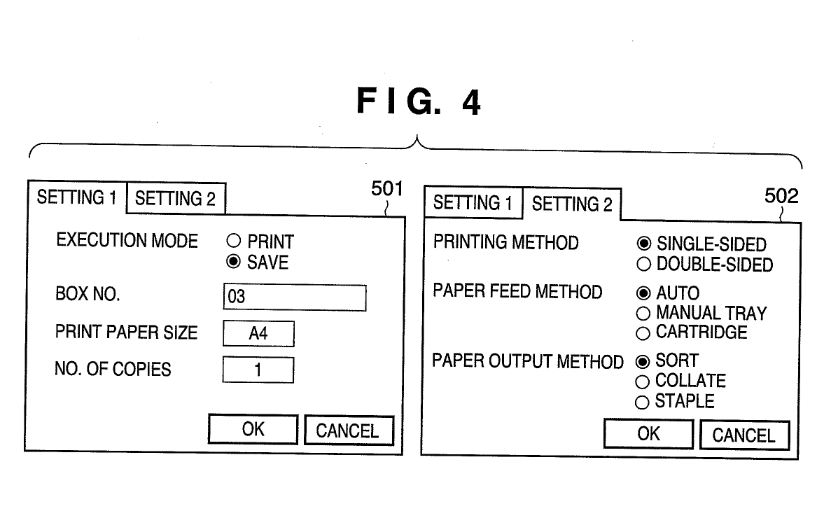

FIG. 4 depicts an example of a printer driver setting screen that is displayed on a display of the external device 2 when the user transmits PDL data created on the external device 2 to the image forming apparatus 1, and either prints or saves the PDL data thereon. As depicted in FIG. 4, the setting screen is configured of two screens 501 and 502.

The setting screen 501 sets an execution mode, a box no., a paper size, and a number of copies. The execution mode sets either “PRINT,” whether to print the image data, or “SAVE,”; whether to store the image data in the box. The box no. is a field that sets in which box to store the image data when specifying “SAVE” as the execution mode, and allows specifying either a single box or a plurality of boxes. The paper size and the number of copies specify a paper size and a number of copies, respectively, when printing.

The setting screen 502 sets a print method, a print paper feed method, and a print paper discharge method, as each respective setting relating to printing. The print method is a field that specifies a single-sided print and a double-sided print as the print paper print method. The print paper feed method is a field that specifies from which print paper port to feed the print paper. The print paper discharge method is a field that selects from among “SORT,” “GROUP,” and “STAPLE” as the discharge method of the print paper.

When the setting of the print driver of the external device 2 is performed, the setting information and the image data, that is, the PDL data, is transmitted to the image forming apparatus 1 by executing the transmission.

Image Data Storage in Image Forming Apparatus

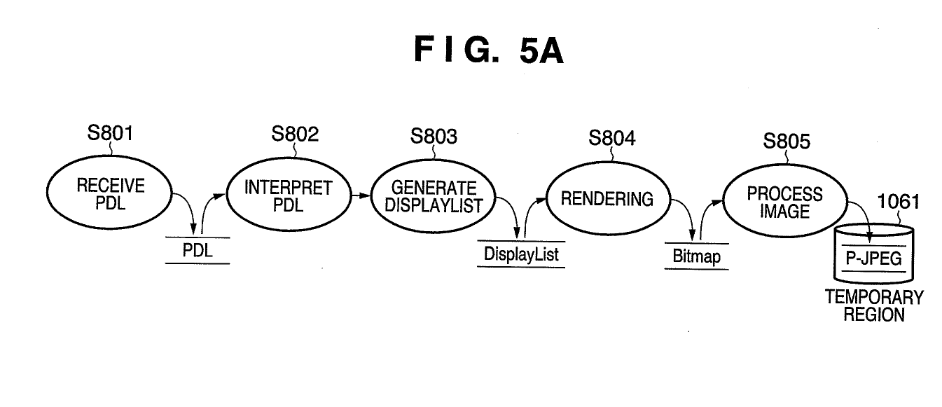

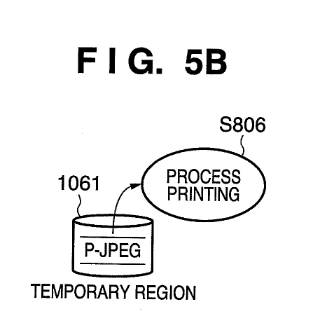

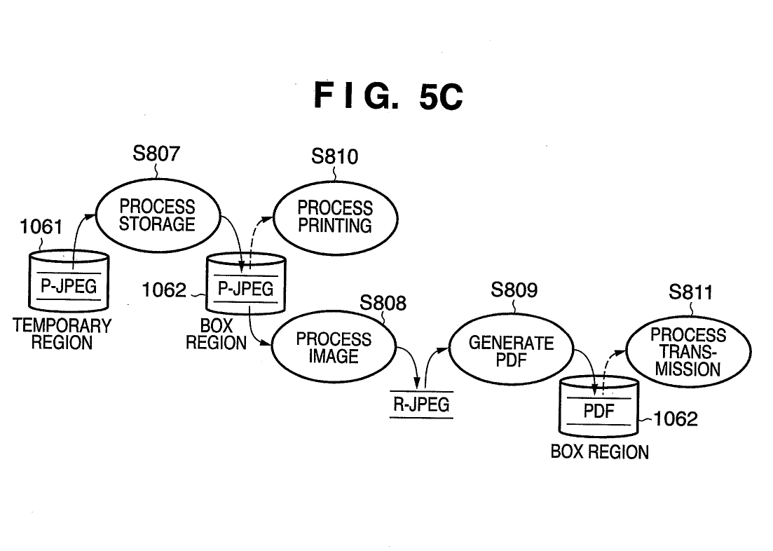

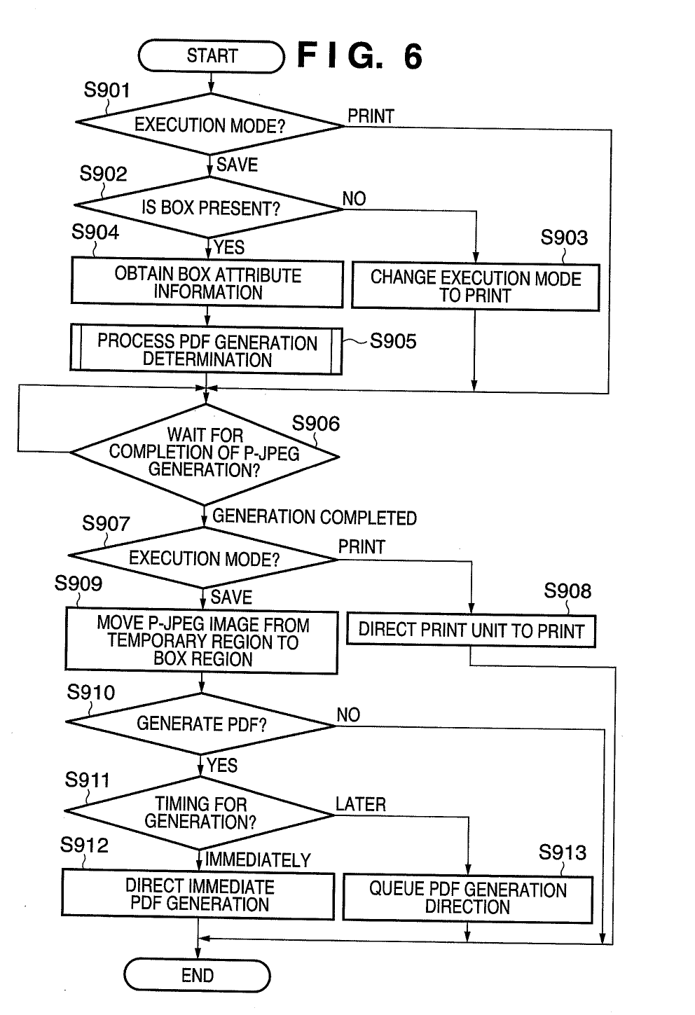

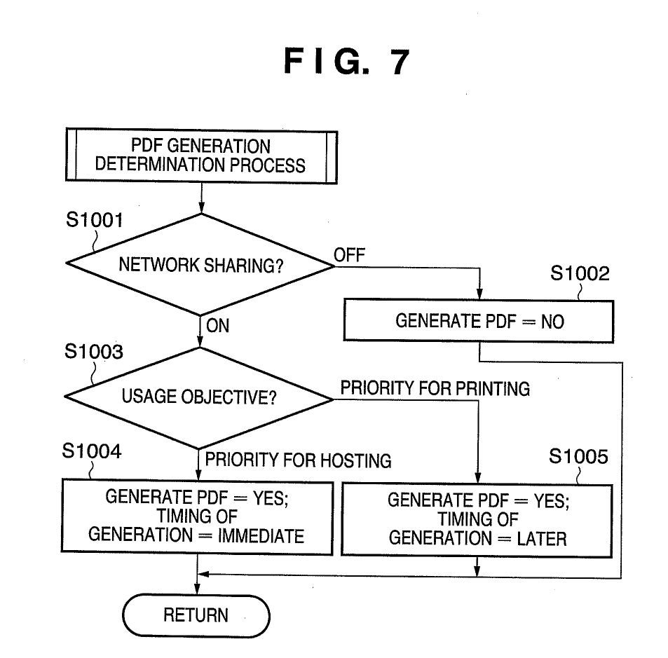

It is possible to store an image in a user-specific box within the image forming apparatus 1, in response to the direction of the user, according to the embodiment. The following is a description of an operation when the storage of the image data is supported on the image forming apparatus 1, with reference to FIG. 1, FIGS. 5A-5C, FIG. 6, and FIG. 7. FIGS. 5A-5C are conceptual diagrams depicting a flow of an image data on the image forming apparatus 1, whereas FIG. 6 and FIG. 7 are flowcharts depicting a PDF data generation control process with regard to the control unit 1004, for both image generation and storage.

When an image data in PDL format (PDL data) is input from the external device 2 to the image forming apparatus, a process of receiving the PDL data is performed in an image input unit 1001. The process corresponds to FIG. 5A, step S801. The image input unit 1001 temporarily stores the received PDL data in the temporary region 1061 in the storage unit 1005, and notifies both a PDL interpreter 1010 and the control unit 1004 that the PDL data has been received.

When the PDL interpreter 1010 finishes interpreting a page of the received PDL data, it passes a result of the interpretation to a display list generation unit (DL generation unit) 1011. The process corresponds to FIG. 5A, step S802.

The DL generation unit 1011 generates a one-page display list based on the interpretation result that is passed from the PDL interpreter 1010, and passes a result of generation to a rendering unit 1012. The process corresponds to FIG. 5A, step S803.

The rendering unit 1012 renders the one-page display list that is passed thereto from the DL generation unit 1011, and generates a one-page image data in a bitmap format. The process corresponds to FIG. 5A, step S804.

An image processing unit 1013 converts the generated one-page bitmap format image data into image data in the P-JPEG format (the P-JPEG data 1006), and stores the converted image data in the temporary region 1061 in the storage unit 1005. The process corresponds to FIG. 5A, step S805.

Repeating the process for as many iterations as there are pages results in the P-JPEG data 1006 for all pages being stored in the temporary region 1061 in the storage unit 1005.

The control unit 1004 executes the PDF generation process depicted in FIG. 6, in parallel with the process from the interpretation of the PDL to the generation of the P-JPEG data.

In step S901, the control unit 1004 examines the setting information that is appended to the received PDL data, and determines whether or not the execution mode is “PRINT” or “SAVE.” If the execution mode is “SAVE,” in step S902, a determination is made as to whether or not the box that is specified by the box no. is in the apparatus, that is, whether or not the specified box is present in the box region 1062 of the storage unit 1005. If the specified box is not present, in step S903, the execution mode is changed to “PRINT.”

If, on the other hand, the specified box is present in the apparatus, in step S904, the attribute information that is set in the box is acquired, and in step S905, a determination is made, based on the attribute information thus acquired, as to whether or not to generate the image data in the PDF format. A detailed description of the determination process will follow hereinafter. Upon obtaining the result of the process of determining whether or not to generate the PDF data, if the result is to generate the PDF data, a further determination result of a timing of executing the process, either immediately or later, is also obtained.

When the PDF generation determination process in step S905 is finished, in step S906, a standby is in place until the process of generating the image data in the P-JPEG format is completed, whereupon, in step S907, a determination is made anew as to whether the execution mode is “PRINT” or “SAVE” If the execution mode is “PRINT,” in step S908, the print unit 1008 is directed to print output the P-JPEG data 1006 that is stored in the temporary region 1061 in the storage unit 1005, and the process sequence terminates. The print unit 1008 print outputs the P-JPEG data 1006 to a recording medium. If the execution mode is “PRINT,” the process corresponds to FIG. 5B, step S806.

If, on the other hand, the execution mode is “SAVE,” in step S909, the P-JPEG data 1006 that is stored in the temporary region 1061 in the storage unit 1005 is moved to the box region that is specified in the box no. The process corresponds to FIG. 5C, step S807. The box region which is specified in the box no. will be referred to hereinafter as “the specified unit box.”

In step S910, a verification is made as to whether the determination in step S905 is to generate, or not to generate, the PDF data. If the determination is not to generate the PDF data, the process sequence ends without performing the generation of the PDF data.

If, on the other hand, the determination is to generate the PDF data, in step S911, an additional verification is made as to whether the execution timing of the generation process is determined to be immediate or later. If the execution timing is determined to be immediate, in step S912, the control unit 1004 directs the image processing unit 1013 and a PDF generating unit 1014 to generate the PDF data immediately, and the process sequence ends. If the execution timing is determined to be later, in step S913, the control unit 1004 directs the image processing unit 1013 and the PDF generating unit 1014 to queue the PDF data generation, and the process sequence ends. In such a circumstance, queueing the PDF data generation refers to generating the PDF data when possible, if not possible immediately. For example, the PDF data would be generated when the image forming apparatus 1 overall is performing no processing, and is in a power conservation time period.

The following is a description of a method of generating the PDF data according to the embodiment. Upon receipt of the PDF data generation instruction from the control unit 1004, the image processing unit 1013 extracts the P-JPEG data 1006 that is stored in the specified unit box region, and converts the P-JPEG data 1006 thus extracted to an image data in a raster JPEG format. The process corresponds to FIG. 5C, step S808, which denotes when the execution mode is “PRINT.” Thereupon the PDF generating unit 1014 generates the PDF data from the image data in the raster JPEG format, and returns the result to the specified unit box region. The process corresponds to FIG. 5C, step S809. It would be possible to arbitrarily output the P-JPEG data 1006 and the PDF data 1007 that are stored in the box region according to an instruction by the user. For example, if the user selects, and directs for printing, the P-JPEG data 1006 that is stored in the unit box region via a console panel (not shown) of the image forming apparatus 1, the print unit 1008 generates and prints a bitmap of the P-JPEG data 1006. The process corresponds to FIG. 5C, step S810. If the external device 2 requests the PDF data 1007 that is stored in the unit box region, in response to the user instruction, the transmission unit 1009 activates a transmission process, and transmits the specified PDF data 1007 via the network to the external device 2. The process corresponds to FIG. 5C, step S811.

Process of PDF Generation Determination from Box Information

FIG. 7 is a flowchart depicting an example of the PDF generation determination process in FIG. 6, step S905, being performed based on the box attribute information.

In step S1001, a verification is made as to whether the network sharing in the box attribute information is on or off. If the box attribute information is off, in step S1002, a determination is made not to perform the PDF data generation. It is determined that the PDF data generation is unnecessary because it is presumed that if the box does not have network sharing enabled, the image which is stored in the box will not be used by the external device 2.

If, on the other hand, network sharing is on, in step S1003, the usage objective is verified. If the usage objective is the priority on hosting, in step S1004, it is presumed that the PDF data generation is to be performed, and that the execution timing thereof is immediate. The reason is that it is determined that, if the usage by the external device 2 is prioritized, usability would be better served by generating the PDF data immediately than by waiting to do so.

If, on the other hand, the usage objective is the priority on printing, in step S1005, it is presumed that the PDF data generation is to be performed, and that the execution timing thereof is later. The reason is that it is determined that the PDF data should be generated at a timing that would not affect the print performance, given that the usage objective is priority on printing, even though the PDF data would be generated because the network sharing is enabled for the box.

While an example has been depicted according to the embodiment of employing the network sharing and the usage objective of the box attribute information to perform the determination, it would be permissible to employ any attribute information that is the attribute information that is set for the box.

Process of PDF Generation Determination from PDL Data

It would be possible for the PDF generation determination process depicted in FIG. 6, step S905 to employ the setting information that is appended to the PDL data that is received from the external device 2, in addition to the method in accordance with the box attributed information such as the method depicted in FIG. 7 perform the determination.

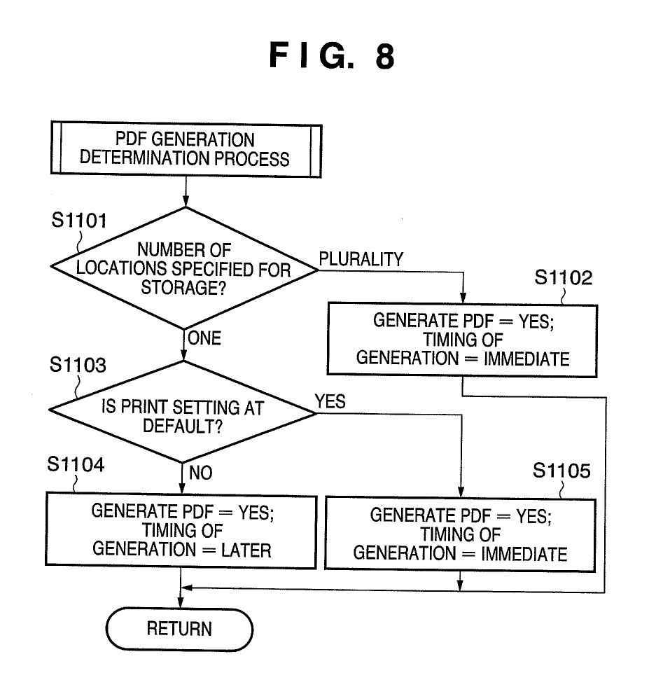

FIG. 8 is a flowchart depicting an example of the PDF generation determination process in FIG. 6, step S905, in accordance with the PDL data setting information.

In step S1101, a verification is made as to whether or not the number of locations specified for storage in the box no. in the setting information is one or a plurality. If it is a plurality, in step S1102, it is presumed that PDF data generation is to be performed, and that the execution timing thereof is immediate. The reason is that it is determined that, if the number of locations specified for storage is a plurality, the image data that is stored is being distributed to a plurality of users, and the users whereto the image data is distributed will print the image data on the external device 2 after verification thereof, that is, it would be more useful to the user to prioritize the hosting usage thereof.

If, on the other hand, one location is specified for storage, in step S1103, a determination is made as to whether or not the print setting is the default. If the print setting is not the default, in step S1104, it is presumed that the PDF data generation is to be performed, and that the execution timing thereof is later, whereas if the print setting is the default, in step S1105, it is presumed that the PDF data generation is to be performed, and that the execution timing thereof is immediate. The reason is that it is determined that, if the print setting is not the default, the user is presumed to intend to print, and thus, it would be best to prioritize the print, and postpone the generation of the PDF data.

In the present circumstance, the print setting denotes the printer driver setting screen depicted in FIG. 4, that is, the print paper size and the number of copies in the settings in the screen 501, and print method, the print paper feed method, and the printout output method in the screen 502. The determination as to whether or not the print setting is the default is performed by storing a preset default value of each respective setting in the image forming apparatus 1, and comparing each respective default value thereof with each respective default value that of the setting information that is received from the external device 2.

### Benefits According to the Embodiment

Benefits as follows may be derived according to the embodiment. It is possible to determine appropriately whether to treat the PDL data that is stored in the box upon being input into the image forming apparatus 1 as either or both of the specific format or the general format, corresponding to such as either the information of the box or the PDL setting information.

Accordingly, it is possible to generate and save either or both of the specific format image or the general format image according to the usage objective, without requiring a complex console operation by the user, thus allowing a balance between usability for the user and performance of the device.

### Second Embodiment

Following is a description according to a second embodiment of the present invention. Whereas the configuration is depicted according to the first embodiment that stores the image data that is input from the external device 2 in the box, a configuration is described according to the second embodiment wherein an image data is stored in a box that is obtained by extracting a source document in a scanner unit. Also described is a method that controls a generation and a storage of an image data when a selection of a box as a storage destination box is allowed on a USB storage or on another device, in addition to the device in question, in response to the storage destination thus selected.

Overview of Image Forming Apparatus

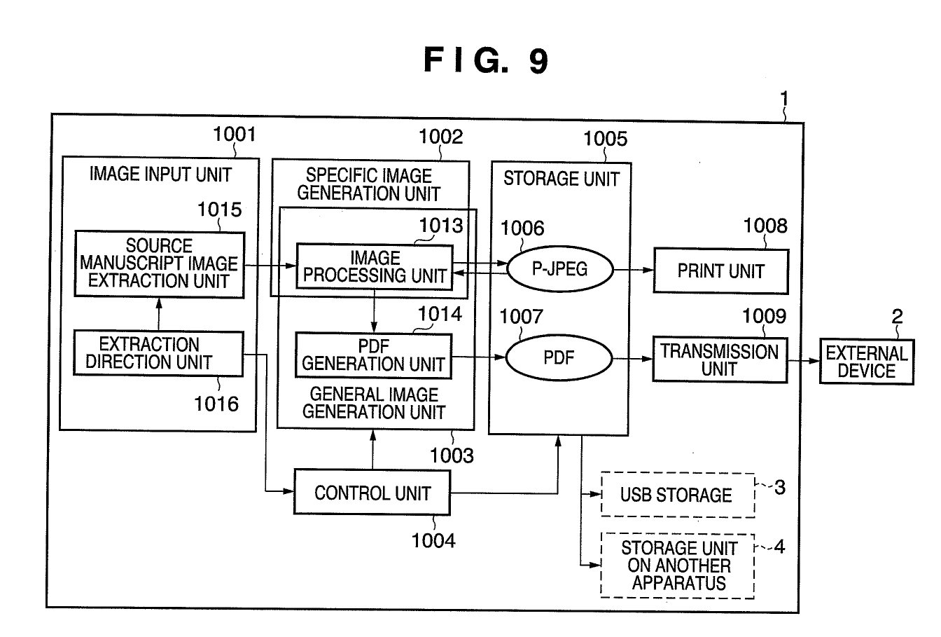

Following is a description of an overview of an image forming apparatus according to the second embodiment. FIG. 9 is a block diagram depicting a configuration of an image forming apparatus according to the second embodiment. A configuration depicted therein that is similar to the configuration that is depicted in FIG. 1, according to the first embodiment, will be marked with an identical reference numeral, and a description thereof will be omitted hereinafter. The image forming apparatus 1 according to the second embodiment is connected, either via a network (not shown), either wired or wireless, to an external device 2, such as a host computer. Reference numeral 3 is a removable USB storage, and reference numeral 4 is a storage unit that is comprised within another image forming apparatus that is connected via the network to the image forming apparatus 1. It is by no means guaranteed, however, that either the USB storage 3 or the storage unit 4 of the other image forming apparatus will be effective with the image forming apparatus 1.

An image input unit 1001 in the image forming apparatus 1 comprises an extraction direction unit 1016, whereby a user directs an extraction of a source manuscript image via a series of console operation screens, and a source manuscript image extraction unit 1015, which performs a process of extracting the source manuscript image according to the direction thereof. According to the second embodiment, the input image data that is subject to the process is thus extracted by the source manuscript image extraction unit 1015, allowing comprising only a general image generation unit 1003, without requiring a PDL interpretation as a configuration of a specific image generation unit 1002.

Each respective data of the specific image and the general image that is stored in a storage unit 1005 according to the second embodiment is similar to the first embodiment, and thus, a detailed description thereof will be omitted hereinafter.

Image Extraction Direction

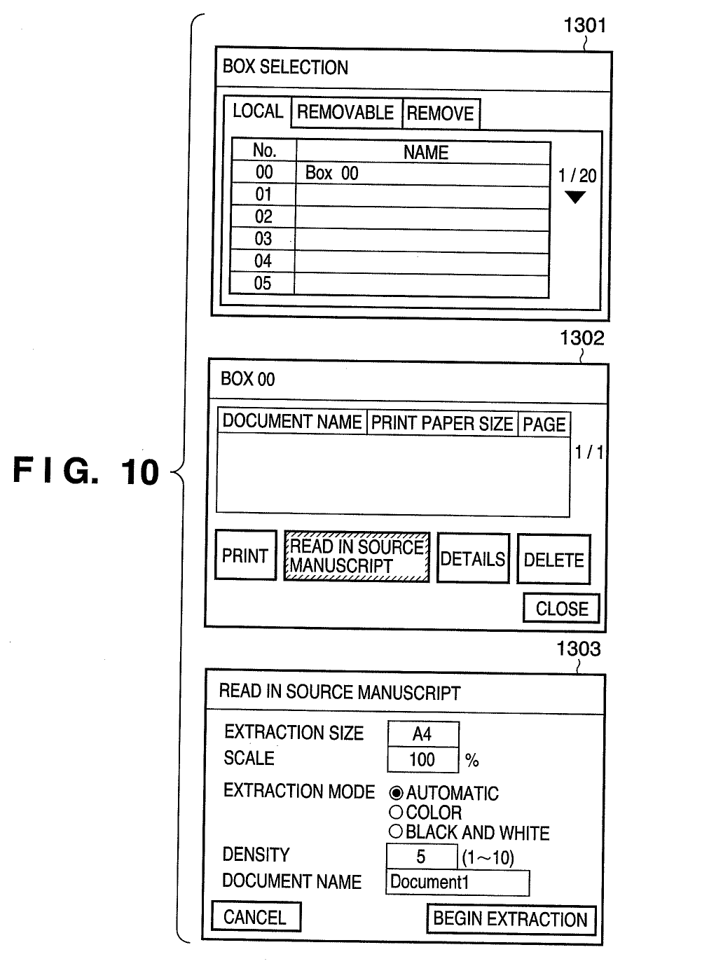

FIG. 10 depicts an example of a console operation screen that is displayed in a console operation panel of the extraction direction unit 1016, in order to direct that a source manuscript be scanned on a source manuscript platform in the source manuscript image extraction unit 1015, and the image data thus obtained be stored in a box in such as the storage unit 1005.

A screen 1301 in FIG. 10 selects a box wherein the image data is to be stored. The user specifies the box wherein the image data is to be stored from within the screen 1301. In the screen 1301, “LOCAL” refers to selecting a unit box as the box wherein the image data is to be stored from a box within the apparatus, that is, a box region 1062. “REMOVABLE” refers to selecting a USB storage, for example, a box region 1063, as the box wherein the image data is to be stored. The selection is possible only when the USB storage 3 is attached to the image forming apparatus 1. “REMOTE” refers to selecting a box of another apparatus that is connected to a network, that is, a box region 1064, as the box wherein the image data is to be stored. The selection is possible only when the box of the other device is pre-set as usable.

When the unit box wherein the image data is to be stored is selected in the screen 1031, the content of the unit box thus selected is displayed in the screen 1302. If a password is set for the unit box, a password input screen (not shown) is displayed, and the screen 1302 is displayed only if an input password matches the set password. The screen 1302 displays a list of the image data that is already stored in the unit box, and performs such control operations as printing, an extraction of a source manuscript, and deletion. Selecting the “Extraction of the Source Manuscript” within the screen brings up a screen 1303.

The screen 1303 is for setting the extraction of the source manuscript. Clicking “Commence Extraction” after performing each respective setting relating to the extraction of the source manuscript causes a scan, that is, an extraction, of the source manuscript that is placed on the source manuscript platform (not shown).

Image Data Storage

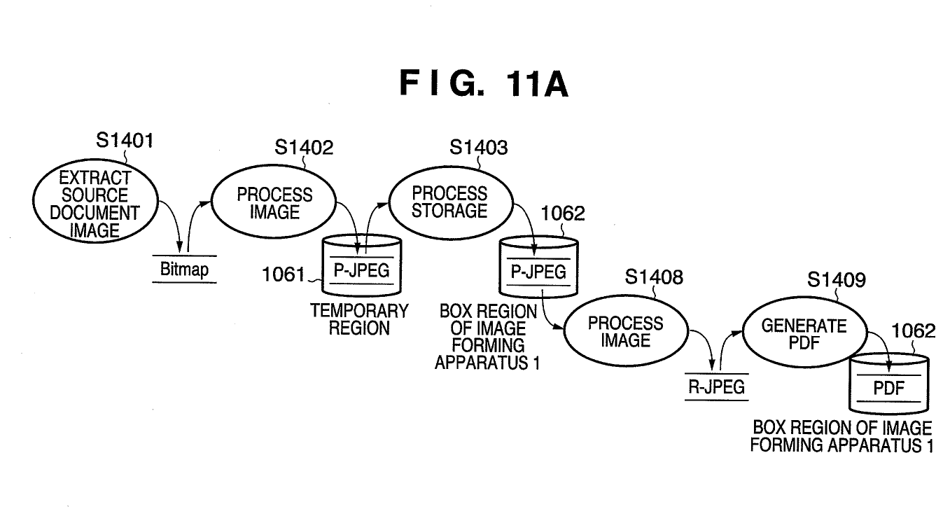

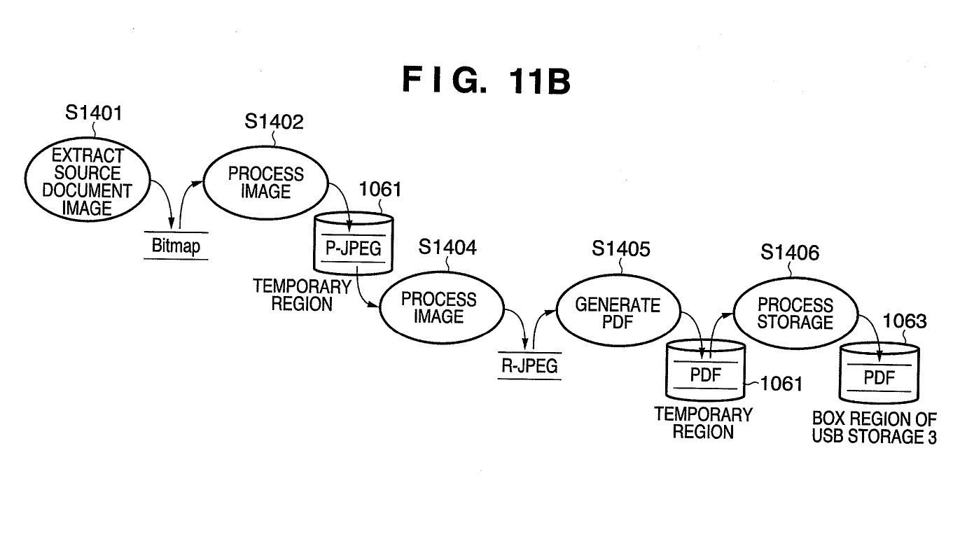

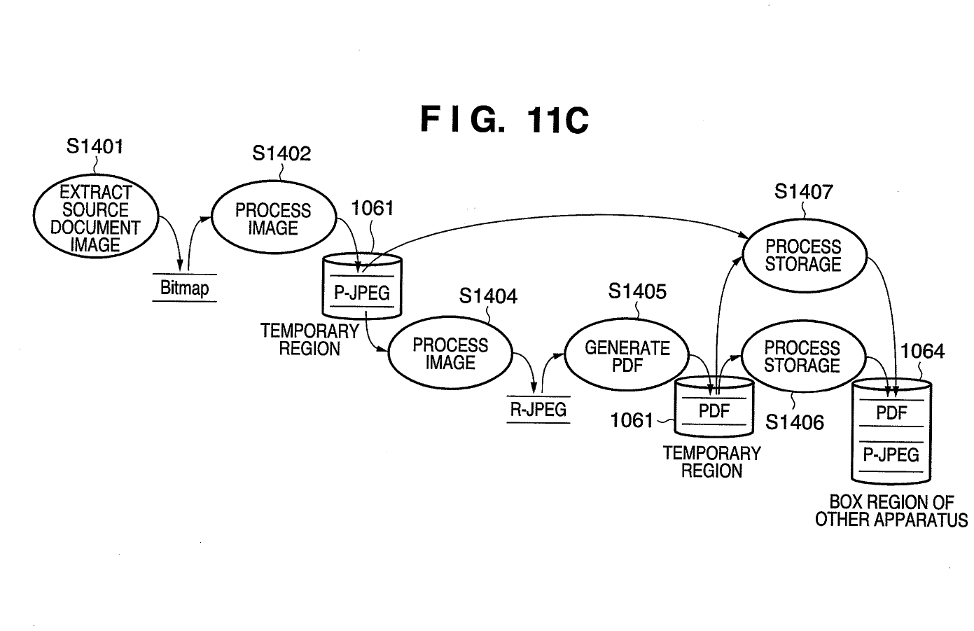

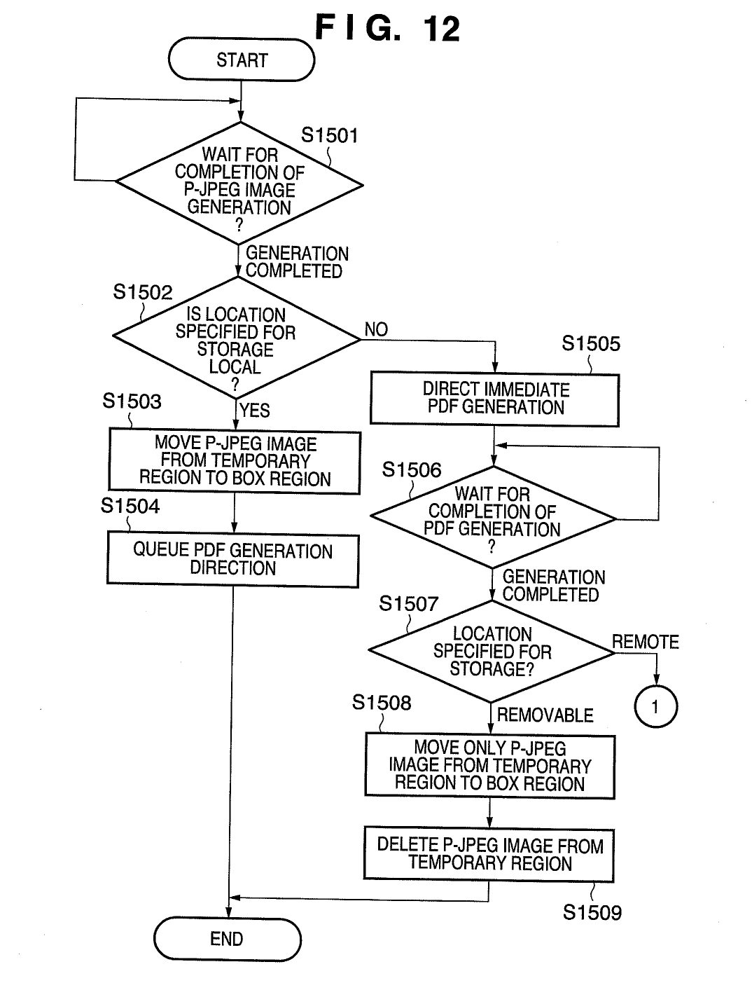

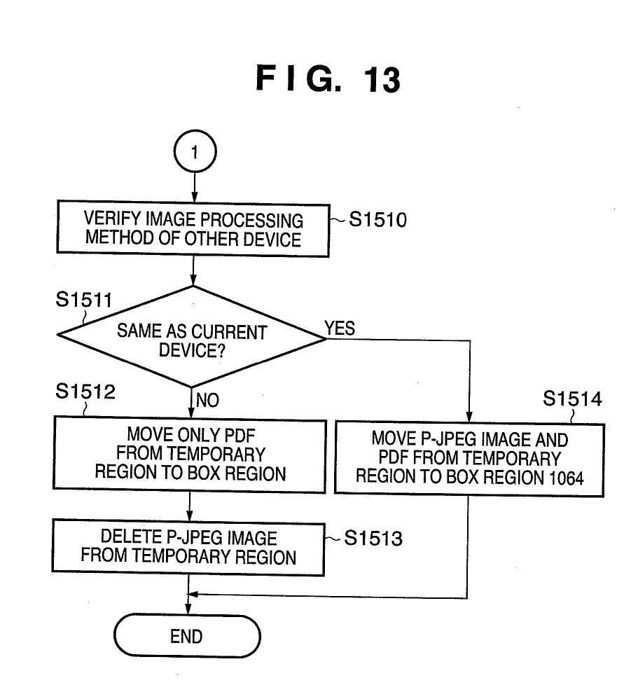

It is possible to store the image data that is extracted from the source manuscript in the image forming apparatus 1 in the selected box in response to the user instruction according to the second embodiment. Following is a description of an operation when the storage of the image data on the image forming apparatus 1 is supported, with reference to FIGS. 11A-11C, FIG. 12, and FIG. 13. FIGS. 11A-11C are conceptual diagrams depicting a flow of an image data. and FIG. 12 and FIG. 13 are flowcharts depicting a PDF generation control process of the control unit 1004.

When the extraction of the source manuscript commences in the image input unit 1001, a bitmap image data of each page thus obtained is temporarily stored in an image memory (not shown), and a notification thereof is passed to the control unit 1004. The process corresponds to FIGS. 11A-11C, step S1401.

The image processing unit 1013 extracts the bitmap image data of each page that is stored in the image memory within the image input unit 1001, converts the bitmap image data thus extracted into the P-JPEG data 1006, and stores the P-JPEG data 1006 thus converted in the temporary region 1061 in the storage unit 1005. The process corresponds to FIGS. 11A-11C, step S1402. The process is controlled in accordance with a control of the control unit 1004.

Repeating the process as many iterations as the number of source manuscript pages results in the P-JPEG data 1006 of all pages being stored in the temporary region 1061 in the storage unit 1005.

The control unit 1004 waits for the generation of the P-JPEG data 1006 to be completed, and controls the PDF data generation process. Following is a description of the PDF data generation process according to the second embodiment, with reference to the flowcharts in FIG. 12 and FIG. 13.

In step S1501, the control unit 1004 is on standby until the general image generation unit 1003 finishes all of the P-JPEG data generation processing. When all of the P-JPEG data generation processing is finished, in step 1502, a determination is made as to whether or not the specified location wherein the image data is to be stored is “LOCAL.”

If the location wherein the image data is to be stored is “LOCAL,” in step S1503, the P-JPEG data 1006 that is stored in the temporary region 1061 is moved to the specified box. The process corresponds to FIG. 11A, step S1403. Given that the location wherein the image data is to be stored is a local box, it is presumed that no particular necessity exists to rush the PDF data generation, and, in step S1504, the PDF generating unit 1014 is directed to queue the PDF data generation, and the process sequence ends. In such a circumstance, queueing the PDF data generation refers to generating the PDF data when the image forming apparatus 1 overall is performing no processing, such as in a power conservation time period, similar to the circumstance according to the first embodiment.

When the PDF data generation is directed after the queueing, the PDF data that is generated via a process denoted by FIG. 1A, steps S1408 and S1409 is stored in the box region 1062. To describe the process in detail, a process such as the following is performed in step S1408. Upon receipt of the PDF generation data instruction from the control unit 1004, the PDF generating unit 1014 extracts the P-JPEG data 1006 that is stored in the box region 1062, and the image processing unit 1013 to convert the P-JPEG data 1006 that is extracted therefrom to an image data of a raster JPEG format.

Hereinafter, the image data of the raster JPEG format is referred to as a raster JPEG (R-JPEG) data. In step S1409, the PDF generating unit 1014 generates the PDF data 1007 from the raster JPEG data, and stores the PDF data 1007 thus generated in the box region 1062.

If, on the other hand, the location wherein the image data is to be stored is not “LOCAL,” in step S1505, the control unit 1004 directs the PDF generating unit 1014 to generate the PDF data immediately.

Following is a description of the reason for rushing the PDF data generation when the location wherein the image data is to be stored is not “LOCAL.” The location wherein the image data is to be stored is not “LOCAL” refers to the “REMOVABLE” and the “REMOTE.” If the location wherein the image data is to be stored is “REMOVABLE,” it is presumed that generating the PDF data immediately would be more useful to the user than postponing the generation thereof, because it is anticipated that the user wants to store the image data on a removable medium on the spot and leave therewith. If the location wherein the image data is to be stored is “REMOTE,” no guarantee is present that the network connection is maintained when the generation of the PDF data is postponed, and it would be impossible to store the image if the connection should be broken.

Following is a description of the PDF generation process of the PDF generating unit 1014, with reference to FIGS. 11A-11C. Upon receipt of the PDF data generation instruction from the control unit 1004, the PDF generating unit 1014 extracts the P-JPEG data 1006 that is stored in the temporary region 1061, and employs the image processing unit 1013 to convert the P-JPEG data 1006 thus extracted to the raster JPEG data. The process corresponds to FIGS. 11A-11C, step S1404. The PDF generating unit 1014 generates the PDF data 1007 from the image data of the raster JPEG format, and stores the PDF data 1007 thus generated in the temporary region 1061. The process corresponds to FIGS. 11A-11C, step S1405.

Returning to FIG. 12, in step S1506, the control unit 1004 is on standby until the PDF generating unit 1014 finishes all of the PDF data generation processing. When all of the generation processing is finished, in step 1507, the location wherein the image data is to be stored is verified again.

If the location wherein the image data is to be stored is “REMOVABLE,” in step S1508, the PDF data 1007 is extracted from the temporary region 1061, and moved to the box region 1063, which corresponds to the USB storage 3. The process corresponds to FIGS. 11A-11C, step S1406. In step S1509, the P-JPEG data 1006 is deleted from the temporary region 1061, and the process sequence ends. The reason for deleting the P-JPEG data 1006 in the present circumstance is that the P-JPEG data 1006 is a device-specific image, lacking a general-purpose applicability to another apparatus, and thus, it is presumed that storing such an image on the removable media is of little advantage.

If, on the other hand, the location wherein the image data is to be stored is “REMOTE,”, in step S1510, a verification is made of an image processing method of the other device that is specified as the location wherein the image data is to be stored, and in step S1511, a determination is made as to whether or not the image processing method of the other device that is specified as the location wherein the image data is to be stored is the same as the image processing method of the present device. As a method of verifying the image processing method of the other device in the present circumstance, it would be permissible to acquire and save the image processing method from the other device when setting the other device to be usable.

If the image processing method of the other device is not the same as the image processing method of the present device, it is presumed that no P-JPEG data compatibility is present. In such a circumstance, in step S1512, only the PDF data 1007 is extracted from the temporary region 1061 and moved to the specified remote box. The process corresponds to FIGS. 11A-11C, step S1406. In step S1513, the P-JPEG data 1006 is deleted from the temporary region 1061, and the process sequence ends.

If, on the other hand, the image processing method of the other device is the same as the image processing method of the present device, it is presumed that P-JPEG data compatibility is present. Accordingly, in such a circumstance, in step S1514, both the P-JPEG data 1006 and the PDF data 1007 are extracted from the temporary region 1061, moved to the remote box that is specified thereupon, and the process sequence ends. The process corresponds to FIG. 11C, step S1407.

### Benefits According to the Second Embodiment

Benefits as follows may be derived according to the second embodiment. It is possible to determine appropriately whether to treat the bitmap data that is input into the image forming apparatus 1 is stored in the box as either or both the specific format or the general format, according to the format of the box, that is, local, removable, or remote.

Accordingly, it is possible to generate and save either or both of the specific format image or the general format image according to the usage objective, without requiring a complex console operation by the user, thus allowing a balance between usability for the user and the performance of the device.

While the image that is input into the image forming apparatus 1 is described according to the second embodiment as the bitmap format, it would be possible for the image to be in the PDL data, in a manner similar according to the first embodiment. In such a circumstance, it would be permissible to perform the interpretation of the PDL of the specific image generation unit 1002, in a manner similar according to the first embodiment.

### Third Embodiment

Following is a description according to a third embodiment of the present invention. An example was depicted according to the first embodiment and the second embodiment wherein the specific format image was generated, and the general format image was generated in accordance therewith. Following is a description of a method of controlling the timing of generating the specific format image in a configuration that generates the specific format image in accordance with the general format image, according to a third embodiment.

Overview of Image Forming Apparatus

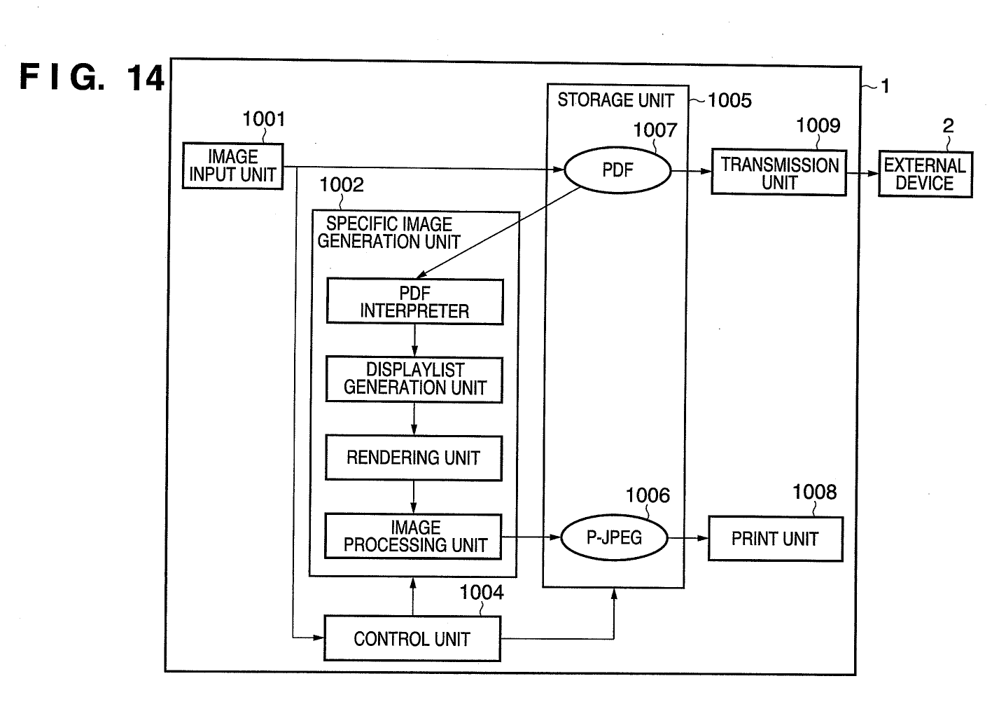

Following is a description of an overview of an image forming apparatus according to the third embodiment. FIG. 14 is a block diagram depicting a function configuration of an image forming apparatus according to the third embodiment. A configuration depicted therein that is similar to the configuration that is depicted in FIG. 1, according to the first embodiment, will be marked with an identical reference numeral, and a description thereof will be omitted hereinafter. The image forming apparatus 1 according to the third embodiment is characterized by not comprising the general image generation unit 1003 such as according to the first embodiment, by directly inputting the PDF data into the image input unit 1001.

According to the third embodiment, the user sets the execution mode, that is, “PRINT” or “SAVE,” and other settings of the external device 2, and transmits the PDF data created thereupon to the image forming apparatus 1. Whereas the document that is created on the external device 2 is converted into the PDL data by the print driver and transmitted in the PDL data format according to the first embodiment, the PDF data that is created on the external device 2 is transmitted as is to the image forming apparatus 1 according to the third embodiment.

Image Data Storage

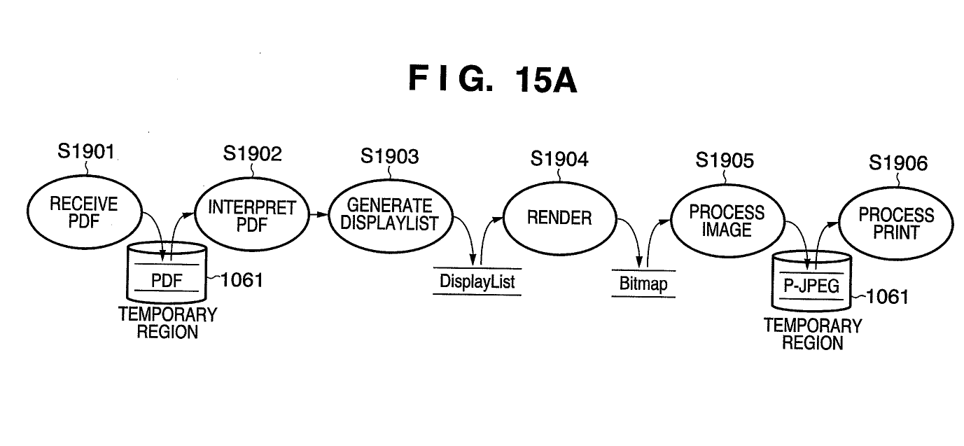

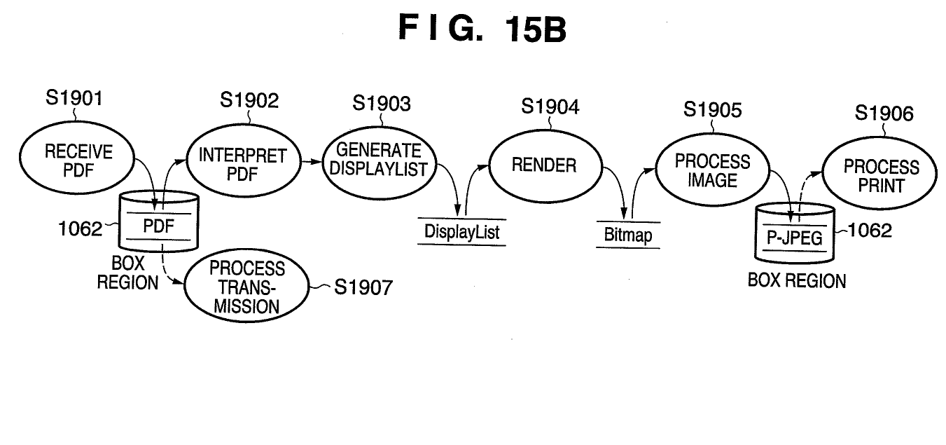

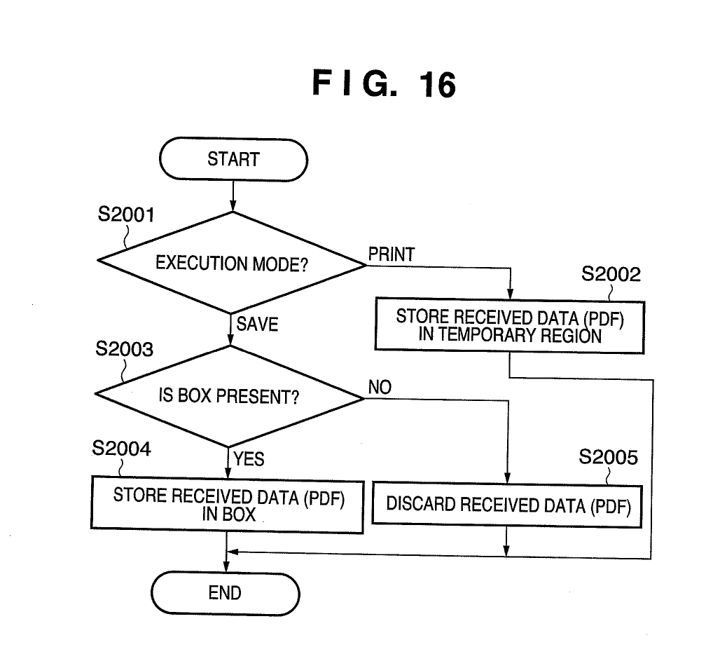

Following is a description of an operation when an image data storage on the image forming apparatus 1 is supported, with reference to FIGS. 15A, 15B, 16, 17, and 18. FIG. 15A and FIG. 15B are conceptual diagrams depicting a flow of an image data, and FIGS. 16, 17, and 18 are flowcharts depicting a P-JPEG generation control process of the control unit 1004.

When an image data in a PDF format (hereinafter “the PDF data”) is input from the external device 2 into the image forming apparatus 1, the image input unit 1001 performs a PDF data reception process. The process corresponds to FIGS. 15A and 15B, step S1901.

FIG. 16 is a flowchart depicting a PDF reception control process of the control unit 1004. In step S2001, the image input unit 1001 interprets the setting information that is appended to the received PDF data, and determines whether the execution mode is “PRINT” or “SAVE.” If the execution mode is “PRINT,” in step S2002, the received PDF data is stored in the temporary region 1061 of the storage unit 1005.

If, on the other hand, the execution mode is “SAVE,” in step S2003, a determination is made as to whether or not the box that is specified by the box no. is present in the box region 1062. If the specified box is present, in step S2004, the received PDF data is stored in the box. If the specified box is not present, in step S2005, the received PDF data is abandoned.

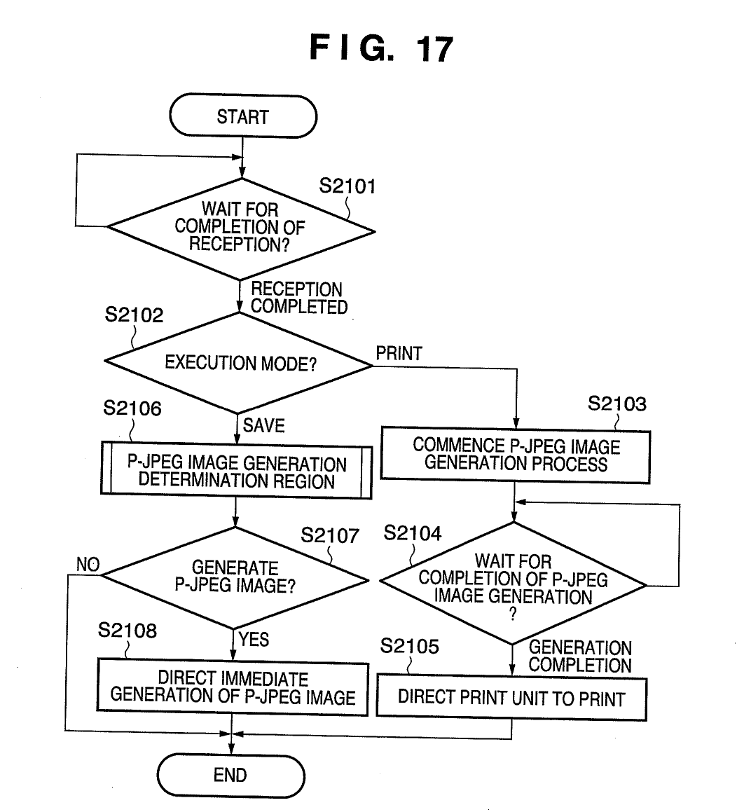

FIG. 17 is a flowchart depicting a P-JPEG generation control process of the control unit 1004. In step S2101, the control unit 1004 is in standby until the image input unit 1001 finishes the PDF data reception process, whereupon, in step S2102, a verification is performed of the execution mode of the setting information. If the execution mode is “PRINT,” in step S2103, the specific image generation unit 1002 is directed to generate the P-JPEG data 1006, whereupon the specific image generation unit 1002 extracts the PDF data 1007 that is stored in the temporary region 1061, interprets, renders, and otherwise processes the PDF as depicted in steps S1902-S1905 as depicted in FIG. 15A and FIG. 15B, and generates the P-JPEG data 1006. Upon generation, the P-JPEG data 1006 is stored in the temporary region 1061 within the storage unit 1005.

Upon completion of the generation of the P-JPEG data 1006 in step S2104, the control unit 1004 directs the print unit 1008 to print the P-JPEG data 1006 in step S2105, and the process sequence ends. Upon receipt of the print direction, the print unit 1008 outputs the P-JPEG data 1006 that is stored in the temporary region 1061 to a printer (not shown) and prints the P-JPEG data 1006 onto a recording medium. The process corresponds to FIGS. 15A and 15B, step S1906.

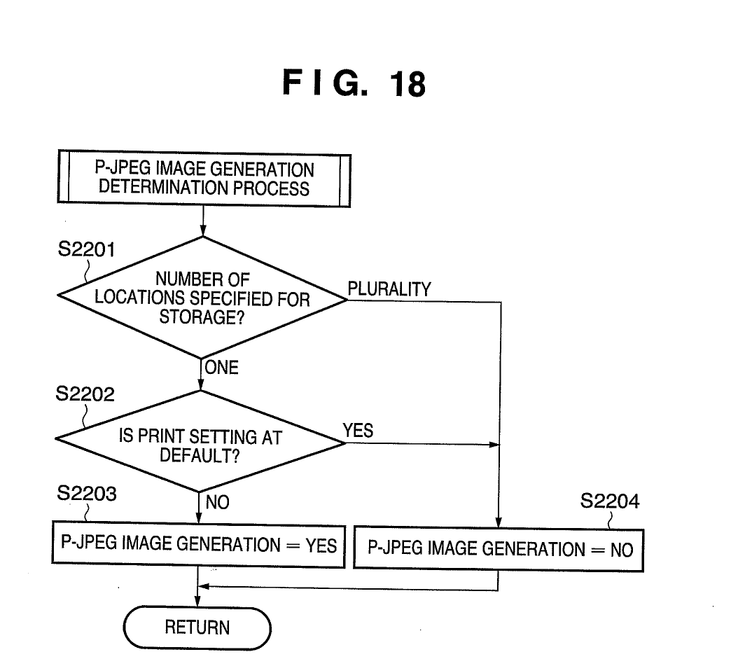

If, on the other hand, the execution mode in step S2102 is “SAVE,” in step S2106, the control unit 1004 performs a generation determination process of the P-JPEG data 1006. Details of the generation determination process of the P-JPEG data will be described hereinafter, with reference to FIG. 18.

Upon completion of the generation determination of the P-JPEG data, in step S2107, the control unit 1004 queries the result of the determination, and if it is determined that the P-JPEG data 1006 will not be generated, the process sequence ends thereupon.

If, on the other hand, it is determined that the P-JPEG data 1006 will be generated, in step S2108, the specific image generation unit 1002 is directed to generate the P-JPEG data 1006 immediately, and the process sequence ends. Thereupon, the specific image generation unit 1002 extracts the PDF data 1007 that is stored in the box, interprets, renders, and otherwise processes the PDF as depicted in steps S1902-S1905 as depicted in FIG. 15A and FIG. 15B, and generates the P-JPEG data 1006, which is then stored in the same box as the PDF data 1007.

It is possible for the user to arbitrarily print output the P-JPEG data 1006 and the PDF data 1007 that are stored together in the same box by making a selection via a console operation panel (not shown) of the forming apparatus 1. If the P-JPEG data 1006 is the selected image, in step S1906, the print unit 1008 outputs only the P-JPEG data 1006 to the printer (not shown), and only the P-JPEG data 1006 is printed thereby. If the PDF data 1007 is the selected image, the P-JPEG data 1006 is generated via the process of steps S1902-S1905 that is depicted in FIG. 15A and FIG. 15B, whereupon the print is performed in the print unit 1008, thus requiring more time to commence printing than the case of the selection of the P-JPEG data 1006.

P-JPEG Generation Determination Process

Following is a detailed description of the P-JPEG image generation determination process according to step S2106, with reference to the flowchart in FIG. 18.

In step S2201, a verification is made as to whether or not the number of locations specified for storage in the box no. in the setting information is one or a plurality. If one location is specified for storage, in step S2202, a determination is made as to whether or not the print setting is the default. If the print setting is not the default, in step S2203, it is presumed that the PDF data generation is to be performed. The reason is that it is determined that, if one location is specified for storage and the print setting is not the default, the likelihood that the print is to be executed promptly is high, and thus, generating the P-JPEG data 1006 at the present time, would be more useful to the user than not doing so.

If, on the other hand, a plurality of locations are specified for storage, or the print setting is the default, in step S2204, it is presumed that the PDF data generation is not to be performed. The reason is that it is determined that, if the plurality of locations are specified for storage, or the print setting is the default, it is unclear as to whether or not the print is to be performed promptly, and thus, it would be permissible to generate the P-JPEG data 1006 when the actual print is directed.

While an example of employing the setting information that is appended to the PDF data 1007 when determining the generation of the P-JPEG data 1006 is depicted according to the third embodiment, it would also be permissible to employ the box attribute information that is preset for the box to make the determination thereof.

### Benefits According to the Third Embodiment

It is possible to receive the general format image on the image forming apparatus 1 and generate the specific format image at the appropriate timing in response to such as the setting information.

Accordingly, it is possible to generate and maintain either or both of the specific format image and the general format image according to the usage objective, without requiring a complicated operation on the part of the user, thus allowing giving equal consideration to convenience for the user on the one hand, and device performance on the other.

### Other Embodiments

While the embodiments have been described in detail, it would be possible for the present invention to take such an embodiment as, for example, a system, an apparatus, a method, a program, or a storage (recording) medium. It would thus be permissible to apply the present invention to a system that is configured of a plurality of devices, such as, for example, a host computer, an interface device, an image capturing apparatus, and a web application, as well as to an apparatus that is formed from a single device.

The present invention is achieved by supplying a software program that implements the function according to the embodiment to the system or the apparatus, either directly or remotely, and a computer of the system or the apparatus loading and executing the program code thus supplied. The program in the present circumstance would be a program that corresponds to the flowchart that is depicted in the drawings according to the embodiment.

Accordingly, the program code itself that is installed on the computer in order to implement the function process of the present invention implements the present invention. The present invention is thus incorporated in the computer program for implementing the function process of the present invention.

In such a circumstance, the program may take such a form as an object code, a program that is executed by an interpreter, or a script that is supplied to an operation system, provided that the function of the program is present.

A medium such as the following may be the recording medium for supplying the program. For example, the recording medium may be such as a floppy disk, a hard drive, an optical disc, a magneto-optical (MO) disk, a CD-ROM, a CD-R, a CD-RW, a magnetic tape, a nonvolatile memory card, a ROM, or a DVD (DVD-ROM, DVD-R).

As a program supply method, the method that is depicted as follows is also possible. A client computer browser connects to a website on the Internet, wherefrom it downloads the computer program of the present invention, or a compressed file containing an automatic install function, to a recording medium such as a hard drive. Implementation would also be possible by segmenting the program code that configures the program of the present invention into a plurality of files, and downloading each file from a different webpage. A World Wide Web server that downloads the program file to implement the function process of the present invention on the computer is thus also included within the present invention.

It would also be possible to encrypt and store the program of the present invention on a storage medium such as a CD-ROM, distribute the storage medium containing the encrypted program, and have the user who satisfies a prescribed condition download a key information from a website on the Internet that decrypts the encryption. The user is thus able to execute, and install on the computer, the encrypted program, by using the key information.

The functions of the embodiments are implemented by the computer executing the program thus loaded. It would also be possible to implement the functions of the embodiments by a process that an operating system or other software running on the computer performs in whole or in part, in accordance with a direction of the program.

The functions of the embodiments are implemented by loading and executing the program that is loaded from the recording medium into a memory that is included in an expansion board that is installed into the computer, or an expansion unit that is connected to the computer. It would thus be possible for a CPU that is included in the expansion board or the expansion unit to perform the actual process, in whole or in part, in accordance with the direction of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-322524, filed Nov. 29, 2006, which is hereby incorporated by reference herein in its entirety.

What is claimed is:

1. An image forming apparatus that is connected to an external device via a network, the apparatus comprising:
an image generating unit adapted to generating, in accordance with a first image data in a first format that the image forming apparatus is capable of interpreting, a second image data in a second format that the external device is capable of interpreting;
a storing unit adapted to storing the first image data and the generated second image data; and
a control unit adapted to controlling the generation of the second image data by the image generating unit, according to an attribute of the storing unit;
wherein
the attribute of the storing unit includes an information that denotes whether or not a sharing exists between the storing unit and the external device that is connected thereto via the network.

2. An image forming apparatus that is connected to an external device via a network, the apparatus comprising:
an image generating unit adapted to generating, in accordance with a first image data in a first format that the image forming apparatus is capable of interpreting, a second image data in a second format that the external device is capable of interpreting;
a storing unit adapted to storing the first image data and the generated second image data; and
a control unit adapted to controlling the generation of the second image data by the image generating unit, according to an attribute of the storing unit;
wherein
the attribute of the storing unit includes an information that denotes a usage objective of the storing unit.

3. An image forming apparatus that is connected to an external device via a network, the apparatus comprising:
an image generating unit adapted to generating, in accordance with a first image data in a first format that the image forming apparatus is capable of interpreting, a second image data in a second format that the external device is capable of interpreting;
a storing unit adapted to storing the first image data and the generated second image data; and
a control unit adapted to controlling the generation of the second image data by the image generating unit, according to an attribute of the storing unit;
wherein
the information that denotes the usage objective of the storing unit includes an information that denotes whether to place a priority on printing, or on a usage by the external device.

4. An image forming apparatus that is connected to an external device via a network, the apparatus comprising:
a first image generating unit adapted to generating a first image data in a first format that the image forming apparatus is capable of interpreting, in accordance with input image data;
a second image generating unit adapted to generating a second image data in a second format that the external device is capable of interpreting, in accordance with the first image data;
a storing unit adapted to storing the generated first image data and the generated second image data; and
a control unit adapted to controlling the generation of the second image data by the second image generating unit, according to an attribute of the input image data.

5. The image forming apparatus according to claim 4, wherein a setting information pertaining to the input image data includes an information that denotes a number of locations specified for storage.

6. The image forming apparatus according to claim 4, wherein the setting information pertaining to the input image data includes an information that denotes a print setting.

7. The image forming apparatus according to claim 4, wherein the setting information pertaining to the input image data includes an information that denotes an attribute of the location specified for storage.

8. The image forming apparatus according to claim 7, wherein the storing unit comprises a first storing unit adapted to being contained within the image forming apparatus, and a second storing unit adapted to being removable from the image forming apparatus;
wherein
the information that denotes the attribute of the location specified for storage includes an information that denotes whether the location specified for storage of the input image data is the first storing unit, the second storing unit, or a storage unit within the external device.

9. The image forming apparatus according to claim 8, wherein the control unit further controls the generation of the second image data in accordance with an image processing method pertaining to the external device, when the location specified for storage of the input image data is the storage unit within the external device.

10. The image forming apparatus according to claim 4, wherein the input image data is a PDL data.

11. The image forming apparatus according to claim 4, wherein the input image data is a bitmap data.

12. The image forming apparatus according to claim 4, wherein the control unit controls whether or not the generation of the second image data by the second image generating unit is allowable.

13. The image forming apparatus according to claim 4, wherein the control unit controls a timing of the generation of the second image data by the second image generating unit.

14. An image forming apparatus that is capable of interpreting an image data in a first format and is connected to an external device via a network, the apparatus comprising:
an image input unit adapted to inputting a second image data in a second image format that the external device is capable of interpreting;
a first image generating unit adapted to generating the image data in the first format in accordance with the input second image data;
a storing unit adapted to storing the generated first image data and the input second image data; and
a control unit adapted to controlling the generation of the first image data by the first image generating unit, according to a setting information pertaining to the second image data.

15. The image forming apparatus according to claim 14, wherein the setting information pertaining to the second image data includes an information that denotes a number of locations specified for storage.

16. The image forming apparatus according to claim 14, wherein the setting information pertaining to the second image data includes an information that denotes a print setting.

17. The image forming apparatus according to claim 1, wherein the storing unit stores the first and the second image data in a box region.

18. The image forming apparatus according to claim 1, further comprising:
a print unit adapted to print outputting the first image data that is stored in the storing unit.

19. The image forming apparatus according to claim 1, further comprising:
a transmission unit adapted to transmitting the second image data that is stored in the storing unit to the external device.

20. The image forming apparatus according to claim 1, wherein the first format is a Packet JPEG format.

21. The image forming apparatus according to claim 1, wherein the second format is a PDF format.
